(19) United States
(12) Patent Application Publication
(10) Pub. No.: US 2019/0158293 A1
(43) Pub. Date: May 23, 2019

(54) KEY STORAGE DEVICE, TRANSACTION METHOD OF KEY STORAGE DEVICE, TRANSACTION SYSTEM AND TRANSACTION METHOD

(71) Applicant: INDUSTRIAL TECHNOLOGY RESEARCH INSTITUTE, Hsinchu (TW)

(72) Inventors: Yao-Hsin CHEN, Hsinchu City (TW); Jui-Ting WU, Zhudong Township (TW); Hsuan-Tung CHEN, New Taipei City (TW)

(73) Assignee: INDUSTRIAL TECHNOLOGY RESEARCH INSTITUTE, Hsinchu (TW)

(21) Appl. No.: 15/841,908

(22) Filed: Dec. 14, 2017

(30) Foreign Application Priority Data
Nov. 20, 2017 (TW) 106140145

(51) Int. Cl. H04L 9/32; G06Q 20/38; H04L 9/08

(52) U.S. Cl. CPC H04L 9/3247; H04L 2209/56; H04L 9/0822; G06Q 20/382

(57) ABSTRACT

A key storage device comprises a one-way receiving interface, a key calculation unit, and a one-way outputting interface. The key calculation unit includes a signature unit. The one-way receiving interface receives a transaction message of an external electronic device in a single direction. The signature unit encrypts the transaction message by a private key to generate a signature message. And, the one-way outputting interface transmits the signature message to the external electronic device in a single direction.

### CROSS-REFERENCE TO RELATED APPLICATION

This application claims the benefit of Taiwan Application Serial Number 106140145, filed Nov. 20, 2017, the subject matter of which is incorporated herein by reference.

### FIELD OF DISCLOSURE

The present disclosure relates to a key storage device, a transaction method of key storage device, a transaction system and a transaction method using one-way link technology.

### DESCRIPTION OF RELATED ART

In the procedure of electronic wallet transactions, the private key represents the ownership of an account. Therefore, how to manage the security of the private key is a challenge. Currently, the private key can be stored off-line by cold storage. However, the cold storage may greatly reduce convenience. Another method is storing the private key in a hardware device having bidirectional transmission interface (e.g., USB, Bluetooth, NFC (Near-field communication), etc.). The electronic wallet software in computer can interact with the hardware device to exchange data through the bidirectional transmission interface. However, the communication between the hardware device and the computer is bidirectional transmission link, the private key may be stolen if the computer has the malicious programs for stealing transaction message and connects to the hardware device.

Therefore, how to provide a key storage device, a transaction method of key storage device, a transaction system and a transaction method with convenience and to avoid the private key being stolen have become a challenge for one of ordinary skill in the art.

### SUMMARY

One exemplary embodiment of the present disclosure is related to a key storage device. The key storage device comprises a one-way receiving interface, a one-way outputting interface and a key calculation unit. The key calculation unit includes a signature unit. The one-way receiving interface receives a transaction message of an external electronic device in a single direction. The signature unit encrypts the transaction message by a private key to generate a signature message. And, the one-way outputting interface transmits the signature message to the external electronic device in a single direction.

Another one aspect of the present disclosure is related to a transaction method of key storage device. The transaction method of key storage device, comprising: receiving a transaction message of an external electronic device in a single direction by a one-way receiving interface; encrypting the transaction message by a private key to generate a signature message by a signature unit; and transmitting the signature message to the external electronic device in a single direction by a one-way outputting interface.

Another one aspect of the present disclosure is related to a key storage device comprises a proxy unit, a one-way receiving interface, a key calculation unit and a one-way outputting interface. The key calculation unit comprises a signature unit. The proxy unit performs a bidirectional transmission link to an external electronic device via a bidirectional transmission interface. The one-way receiving interface receives a transaction message of the external electronic device in a single direction. The signature unit encrypts the transaction message by a private key to generate a signature message. The one-way outputting interface transmits the signature message to the proxy unit, and the proxy unit transmits the signature message to the external electronic device in a single direction.

Another one aspect of the present disclosure is related to a transaction system. The transaction system comprises an external electronic device and a key storage device. The key storage device comprises a proxy unit, a one-way receiving interface, a key calculation unit and a one-way outputting interface. The key calculation unit comprises a signature unit. The external electronic device transmits or displays a transaction message. The proxy unit performs a bidirectional transmission link to the external electronic device via a bidirectional transmission interface. The one-way receiving interface receives the transaction message of the external electronic device in a single direction e. The signature unit encrypts the transaction message by a private key to generate a signature message. The one-way outputting interface transmits the signature message to the proxy unit, and the proxy unit transmits the signature message to the external electronic device in a single direction.

Another one aspect of the present disclosure is related to a transaction method. The transaction method comprises: transmitting or display a transaction message by an external electronic device; performing a bidirectional transmission link to the external electronic device via a bidirectional transmission interface by a proxy unit; receiving the transaction message of the external electronic device in a single direction by a one-way receiving interface; encrypting the transaction message by a private key to generate a signature message by a signature unit; and transmitting the signature message to the proxy unit, and the proxy unit transmits the signature message to the external electronic device in a single direction by a one-way outputting interface.

Based on above, the present disclosure provides a key storage device, a transaction method of key storage device, a transaction system and a transaction method can establish the one-way link to the external electronic device by the one-way receiving/outputting interface, so as to use the one-way outputting interface transmits the signature message to the external electronic device via the output port. Based on using the one-way transmission method to transmit the signature message transmission, the one-way outputting interface cannot receive the access information from the external electronic device. Therefore, the one-way link can avoid the external electronic device invading the one-way outputting interface to obtain other information of the key storage device or the transaction system. Thus, the transaction method of key storage device, the transaction system and the transaction method can achieve the effect of increasing the safety of transaction.

### BRIEF DESCRIPTION OF THE DRAWINGS

The disclosure can be more fully understood by reading the following detailed description of the embodiment, with reference made to the accompanying drawings as follows:

FIG. 1 is a block diagram of transaction system according to one embodiment of the present disclosure.

FIG. 2 is a schematic diagram of the transaction method of key storage device according to one embodiment of the present disclosure.

FIG. 3 is a schematic diagram of the transaction method of key storage device according to one embodiment of the present disclosure.

FIG. 4 is a block diagram of a transaction system according to one embodiment of the present disclosure.

FIG. 5 is a schematic diagram of the transaction method of key storage device according to one embodiment of the present disclosure.

FIG. 6 is a schematic diagram of the transaction method of key storage device according to one embodiment of the present disclosure.

### DETAILED DESCRIPTION OF DISCLOSED EMBODIMENTS

Reference will now be made in detail to the present embodiments of the disclosure, examples of which are illustrated in the accompanying drawings. Wherever possible, the same reference numbers are used in the drawings and the description to refer to the same or like parts.

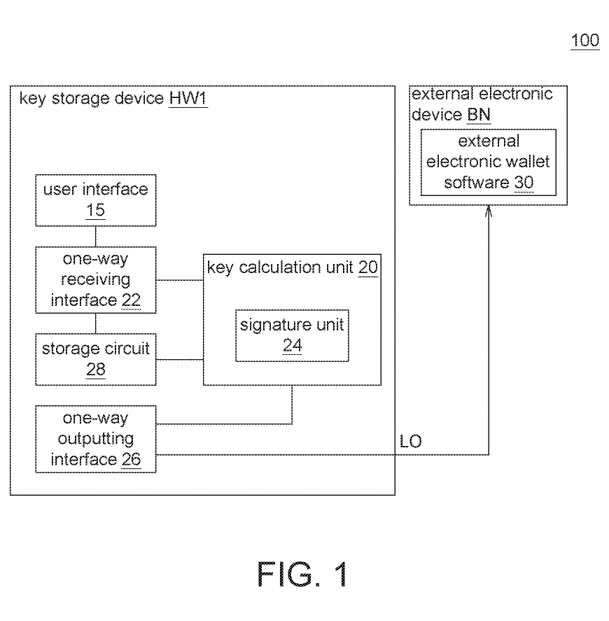

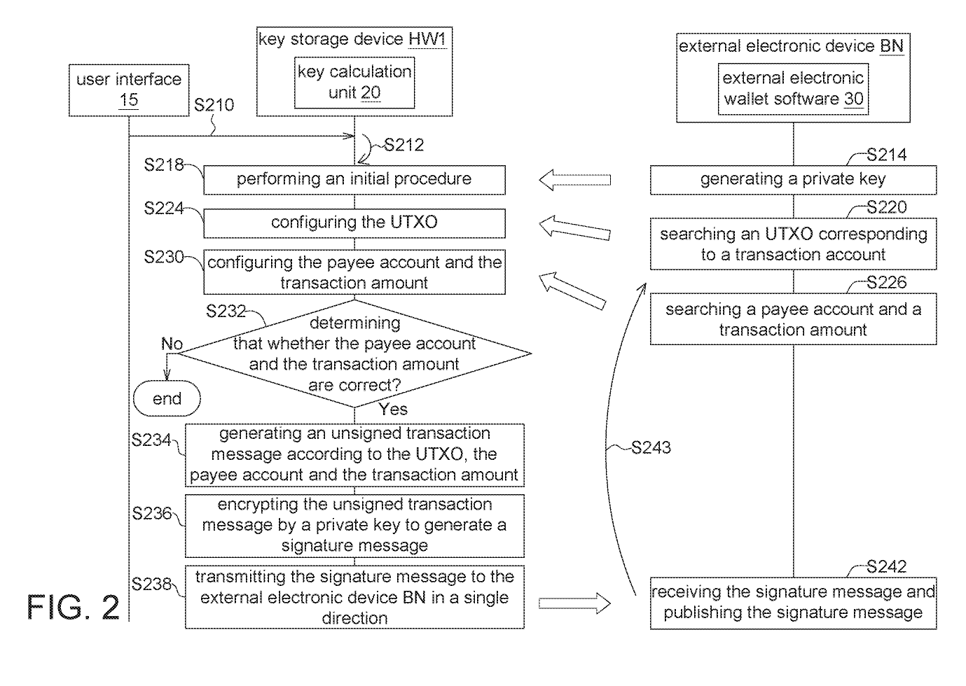

It will be understood that, although the terms “first,” “second,” etc. may be used herein to describe various elements, these elements should not be limited by these terms. These terms are only used to distinguish one element from another. For example, a first element could be termed a second element, and, similarly, a second element could be termed a first element, without departing from the scope of the embodiments. Reference is made to FIGS. 1-2. FIG. 1 is a block diagram of transaction system 100 according to one embodiment of the present disclosure. FIG. 2 is a schematic diagram of the transaction method of key storage device according to one embodiment of the present disclosure.

In one embodiment, the transaction system 100 includes a key storage device HW1. The key storage device HW1 comprises a one-way receiving interface 22, a key calculation unit 20, a one-way outputting interface 26 and a storage circuit 28. The key calculation unit 20 comprises a signature unit 24. In one embodiment, the key storage device HW1 further comprises a user interface 15.

In one embodiment, the one-way receiving interface 22 can be a quick response code (QR code) scanner, a bar code scanner or a single direction receiver, for example, the receiver of light, sound waves or infrared. The one-way outputting interface 26 can be a QR code encoder, a bar code encoder or an emitter, for example, the emitter of light, sound waves or infrared. The key calculation unit 20 can be implemented by a microcontroller, a microprocessor, a digital signal processor, an application specific integrated circuit (ASIC), or a logic circuit. The storage circuit 28 stores the code of the key calculation unit 20, the information received by the key storage device HW1, etc. The storage circuit 28 can be implemented by hard disk, flash memory, Static Random-Access Memory (SRAM) or Dynamic Random Access Memory (DRAM), etc. The user interface 15 can be a keyboard, a mouse, a touching panel or the combination of multiple physical keys with a display.

In one embodiment, the transaction system 100 comprises a key storage device HW1 and an external electronic device BN. The external electronic device BN can be a desktop, a server, a smart phone, a panel or other electronic device with calculating function.

In one embodiment, the key storage device HW1 can be an independent device for storing private key. The key storage device HW1 can establish a communication link with the computer (e.g., the external electronic device BN).

In one embodiment, the one-way receiving interface 22 of the key storage device HW1 receives the transaction message from the external electronic device BN and transmits the transaction message to the storage circuit 28. The signature unit 24 obtains the transaction message from the storage circuit 28 and encrypts the transaction message by a private key to generate a signature message. The key calculation unit 20 transmits the signature message to the one-way outputting interface 26. The one-way outputting interface 26 transmits the signature message to the external electronic device BN in a single direction. In other words, the storage device HW1 can obtain the private key and transaction message via the one-way receiving interface 22 from the external electronic device BN. The connection between the one-way receiving interface 22 and the external electronic device BN is unidirectional. For example, the external electronic device BN cannot directly access the one-way receiving interface 22. It can avoid that the external electronic device BN obtaining the data (e.g., private key) from the key storage device HW1.

In one embodiment, the one-way outputting interface 26 transmits a signature message to the external electronic device BN via the one-way link LO. By the one-way link LO between the one-way outputting interface 26 and the external electronic device BN, the signature message can be transmitted safely to the external electronic device BN. And, the external electronic device BN cannot directly access the one-way outputting interface 26. Therefore, it can avoid the malicious program obtaining the data (e.g., unsigned transaction message or private key) from the key storage device HW1 via the one-way outputting interface 26 when the external electronic device BN includes malicious program. As such, the configuration of the one-way receiving interface 22 and the one-way outputting interface 26 in the key storage device HW1 can further avoid the key storage device HW1 being hacked. And, the hacker cannot obtain the private key stored in the key storage device HW1. In this manner, the private key and information stored in the key storage device HW1 is highly secure.

The steps of transaction method of key storage device 200 are described as follows. For the convenience of description, the following description refers to FIG. 1 to FIG. 2 together.

In step S210, user interface 15 inputs a personal identification number code (PIN code) to the one-way receiving interface 22 of the key storage device HW1. In one embodiment, the PIN code can be a serial string (using uppercase English letters, lowercase English letters, symbols and/or numbers) of personal password, a set of account and password, fingerprint recognition input or iris recognition input. User can input the PIN code by user interface 15. In another embodiment, user can input the PIN code by the external electronic wallet software 30. In step S210, the one-way receiving interface 22 of the key storage device HW1 receives the PIN code (not shown) of the external electronic device BN, so as to reduce the button design of the user interface 15 of the key storage device HW1.

In step S212, the one-way receiving interface 22 transmits the PIN code to the key calculation unit 20. The key calculation unit 20 performs user identity verification according to the PIN code. In one embodiment, the key calculation unit 20 determines whether the received PIN code is the same as one of the PIN codes stored in storage circuit 28. If the key calculation unit 20 determines the received PIN code is the same as one of the PIN codes stored in storage circuit 28, the user identity verification is passed and step S218 is prepared to perform. If the key calculation unit 20 determines the received PIN code is not the same as one of the PIN codes stored in storage circuit 28, the key calculation unit 20 transmits an error signal and ends the process. In one embodiment, the step S212 can perform user identity verification by known technology (e.g., comparing that whether the account number and the password are correct). Thus, it is no more further description herein.

In one embodiment, the external electronic device BN includes an external electronic wallet software 30. When the key calculation unit 20 performs the initial procedure, the external electronic wallet software 30 can generate a private key in step S214. The external electronic wallet software 30 can generate the private key according to the transaction account (e.g., a payer account) corresponding to the key storage device HW1. In step S218, the key storage device HW1 performs an initial procedure. In one embodiment, the key storage device HW1 configures the private key. Once the private key is configured, the private key need not be configured again in subsequent processes. As such, the private key configuration will only be executed once.

In one embodiment, the one-way receiving interface 22 receives a private key from the external electronic device BN and stores the private key in the storage circuit 28 before the one-way receiving interface 22 of the key storage device HW1 receives the first transaction message. In one embodiment, the external electronic device BN can encode the private key to a quick response code (QR code) or a bar code. The one-way receiving interface22 of the key storage device HW1 scans the QR code or the bar code to receive and store the private key to finish the procedure of initialize the key storage device HW1. In this way, the external devices cannot obtain the private key stored in the storage circuit 28 from the one-way receiving interface 22 and the one-way outputting interface 26. After finishing the initial procedure, the step S220 is performed.

In step S220, the external electronic wallet software 30 of the external electronic device BN searches an unspent transaction output (UTXO) corresponding to a transaction account (e.g., payer account) and encodes the UTXO as a QR code or a bar code. The UTXO is an unspent transaction output, which is a core concept for generating and verifying the Bitcoin. Due to the concept that the transaction of Bitcoin using UTXO as a basic unit is known, it is no more further description herein.

For the convenience to describe, in the following embodiments, the electronic wallet software 30 encodes the UTXO to the QR code, and takes QR code as an example. The embodiment of the present disclosure is not limited thereto, the UTXO can be encoded as a bar code or other electronic signal for transmission conveniently.

In one embodiment, the electronic wallet software 30 displays the QR code generated from the UTXO on a display device of the external electronic device BN.

In step S224, the key calculation unit 20 configures the UTXO. The one-way receiving interface 22 scans the QR code displayed by the external electronic device BN. And, the one-way receiving interface 22 transmits the QR code to the key calculation unit 20. The key calculation unit 20 decodes the QR code to obtain the UTXO, configures the UTXO in the key storage device HW1, and stores the UTXO to the storage circuit 28. After finishing the step S244, step S226 is performed.

In step S226, the external electronic wallet software 30 of the external electronic device BN searches a payee account and a transaction amount corresponding to the transaction account, and encodes the payee account and the transaction amount as a QR code.

In one embodiment, the external electronic wallet software 30 displays the QR code generated based on the payee account and the transaction amount on a display device of the external electronic device BN.

In step 230, the key calculation unit 20 configures the payee account and the transaction amount. The one-way receiving interface 22 of the key storage device HW1 scans the QR code displayed by the external electronic device BN and transmits the QR code to the key calculation unit 20. The key calculation unit 20 decodes the QR code to obtain the payee account and the transaction amount, configures the payee account and the transaction amount in the key storage device HW1, and stores the payee account and the transaction amount in the storage circuit 28.

In one embodiment, the key storage device HW1 can directly receive the private key and transaction message from external devices via the one-way receiving interface 22. The transaction message includes the UTXO, the payee account and/or the transaction amount. In another embodiment, the key storage device HW1 can directly receive the PIN code, the private key and transaction message from external devices via the one-way receiving interface 22.

In one embodiment, in step S226, the external electronic wallet software 30 of the external electronic device BN searches the payee account and the transaction amount corresponding to the transaction account and encodes the payee account and the transaction amount as a QR code. In step 230, after the one-way receiving interface 22 of the key storage device HW1 receiving the payee account and the transaction amount, the key calculation unit 20 configures the payee account and the transaction amount and stores the payee account and the transaction amount in the storage circuit 28. In another embodiment, the external electronic wallet software 30 of the external electronic device BN searches the payee account corresponding to the transaction account and encode the payee account as the QR code, the key storage device HW1 receives the payee account via the one-way receiving interface 22. And, the user inputs a transaction amount via the user interface 15. The user interface 15 transmits the transaction amount to the one-way receiving interface 22. In this way, the configuration and the storing procedure of the payee account and the transaction amount in the key storage device HW1 are finished.

In one embodiment, the one-way receiving interface 22 is a QR code scanner for scanning the QR code shown by the external electronic device BN, so as to receive the transaction message transmitted/shown by the external electronic device BN.

In one embodiment, the one-way receiving interface 22 is a bar code scanner for scanning the bar code shown by the external electronic device BN, so as to receive the transaction message transmitted/shown by the external electronic device BN.

The one-way receiving interface 22 is unidirectional for the QR code, the bar code or other scanning signals from the external electronic device BN. The QR code, the bar code or other scanning signals from the external electronic device BN obtained by the one-way receiving interface 22 is transmitted to the key calculation unit 20 to store into the storage circuit 28 in a single direction. The one-way receiving interface 22 does not send back any message to the external devices.

In one embodiment, the key calculation unit 20 decodes the QR code, the bar code or other scanning signals from the external electronic device BN and transmits the decoded private key and transaction message to the storage circuit 28.

In step S232, the key calculation unit 20 determines that whether the payee account and the transaction amount are correct. If the payee account and the transaction amount are correct, step S234 is performed. If the payee account and the transaction amount are not correct, the process is ended.

In step S234, the key calculation unit 20 generates an unsigned transaction message according to the UTXO, the payee account and the transaction amount. In one embodiment, referring to FIGS. 1-2, the key calculation unit 20 generates the unsigned transaction message and stores the unsigned transaction message to the storage circuit 28. In another embodiment, referring to FIG. 2, the key calculation unit 20 generates the unsigned transaction message according to the transaction message (e.g., the payee account and the UTXO) received by the one-way receiving interface 22 and the transaction amount inputted by the user interface 15. And, the key calculation unit 20 stores the unsigned transaction message in the storage circuit 28.

In step S236, the signature unit 24 reads the unsigned transaction message from the storage circuit 28, encrypts the unsigned transaction message by a private key to generate a signature message, and transmits the signature message to the one-way outputting interface 26.

In step S238, the one-way outputting interface 26 transmits the signature message to the external electronic device BN in a single direction.

In one embodiment, the communication between the one-way outputting interface 26 and the external electronic device BN is a one-way link. The one-way outputting interface 26 transmits the signature message to the external electronic device BN via an output port. The one-way outputting interface 26 cannot receive an access message from the one-way outputting interface 26. By the one-way link (the one-way outputting interface 26 only can transmit message to the external electronic device BN in a single direction, and the one-way outputting interface 26 cannot receive the message or request from the external electronic device BN), it can avoid external electronic device BN obtaining other information by invading the one-way outputting interface 26.

In step S242, the external electronic device BN receives the signature message and publishes the signature message.

Besides, the transaction identification code of each transaction may different. Thus, when the transaction system 100 wants to process next transaction, as shown by step S243, the process returns to step S220.

In this way, the external electronic device BN only can receive the signed signature message. Each communication between the one-way receiving interface 22, the one-way outputting interface 26 and the external electronic device BN are one-way link. The one-way receiving interface 22 and the one-way outputting interface 26 cannot receive bidirectionally the request signal or data from the external electronic device BN. Thus, the external electronic device BN cannot invade the one-way receiving interface 22 and the one-way outputting interface 26 to obtain the information (e.g., private key) of the key storage device HW1. As such, the transaction system 100 can safely complete the signature and transmit the signature message unidirectionally to the external electronic device BN.

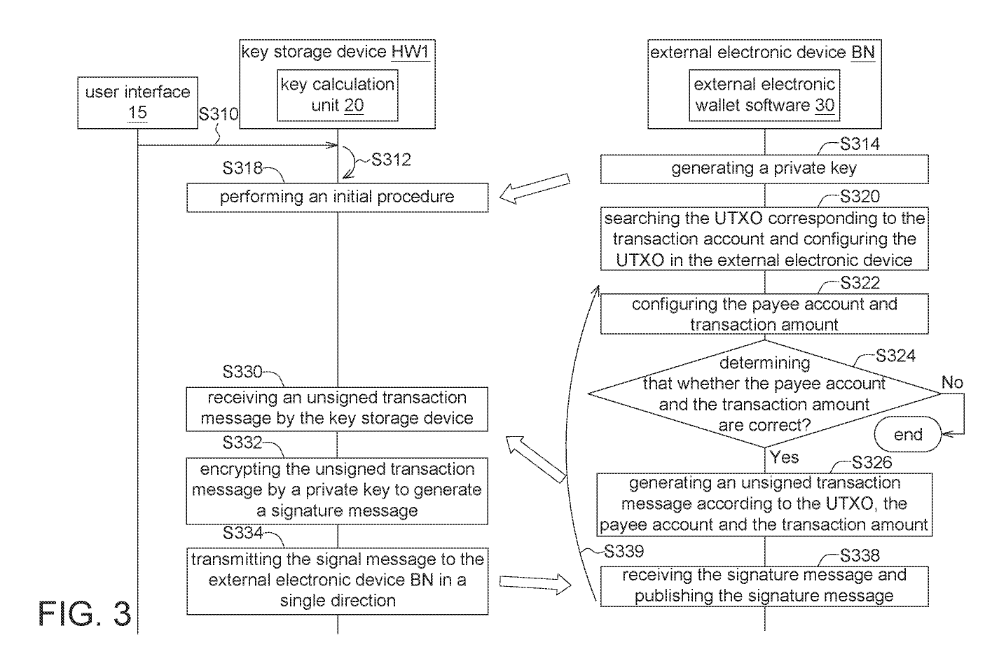

Referring to FIG. 3, FIG. 3 is a schematic diagram of the transaction method of key storage device according to one embodiment of the present disclosure. The key storage device HW1, the user interface 15, the key calculation unit 20, and the external electronic device BN in FIG. 3 are all the same as those in FIG. 2. Thus, it is no more further description herein. Besides, the steps S310, S312, S314, S318, S332, S334, S338 and S339 in FIG. 3 are separately the same as steps S210, S212, S214, S218, S236, S238, S242 and S243. Thus, it is no more further description herein. The details of the steps S320 to S330 of FIG. 3 different from FIG. 2 will be described below.

In step S320, the external electronic wallet software 30 of the external electronic device BN searches the UTXO corresponding to the transaction account and configures the UTXO in the external electronic device BN.

In step S322, the external electronic device BN configures the payee account and the transaction amount.

In one embodiment, the external electronic wallet software 30 of the external electronic device BN configures the payee account and the transaction amount. In one embodiment, the payee account and the transaction amount can be obtained from the external electronic wallet software 30, other electronic device or inputted by user.

In step S324, the external electronic device BN determines that whether the payee account and the transaction amount are correct. If the payee account and the transaction amount are correct, step S326 is performed. If the payee account and the transaction amount are not correct, the process is ended.

In step S326, the external electronic device BN generates an unsigned transaction message according to the UTXO, the payee account and the transaction amount. The external electronic wallet software 30 displays the QR code generated by the unsigned transaction message on the display device of the external electronic device BN.

In order to facilitate the description, the following embodiments encode the unsigned transaction message as the QR code by the electronic wallet software 30, and take the QR code as an example. The embodiment of the present disclosure is not limited thereto. The unsigned transaction message may also be encoded as a bar code or other electronic signal for transmission conveniently.

In step S330, the key storage device HW1 records the transaction message received by the one-way receiving interface 22 as an unsigned transaction message and stores the unsigned transaction message to the storage circuits 28. The one-way receiving interface 22 of the key storage device HW1 scans the QR code displayed by the external electronic device BN and transmits the QR code to the key calculation unit 20. The key calculation unit 20 decodes the QR code to obtain the unsigned transaction message (the UTXO, the payee account and the transaction amount). The key calculation unit 20 stores the unsigned transaction message (the UTXO, the payee account and the transaction amount) to the storage circuit 28.

Next, the signature unit 24 reads the unsigned transaction message from the storage circuit 28 and signs the unsigned transaction message (step S332). The steps S332, S334, S338 in FIG. 3 are separately the same as steps S236, S238, S242. Thus, it is no more further description herein.

Based on above, in the embodiment of FIG. 3, the external electronic device BN uses for searching and configuring the UTXO (step S320) and configuring the payee account and transaction amount (step S322). The key storage device HW1 does not need to obtain the information. As such, it is more efficient that directly finishing the configurations related to the transaction by the external electronic device BN. And, the key storage device HW1 signs the unsigned transaction message. It can reduce the calculation loading of the key storage device HW1.

The procedures shown in the above FIGS. 2-3 can be applied to the transaction process of Bitcoin. In some embodiment, if the steps S220 and S224 in FIG. 2 related to the UTXO are deleted, the method for storing a key as shown in FIG. 2 may be applied to the transaction process of Ethereum. Similarly, in some embodiment, if the step S320 in FIG. 3 related to the UTXO is deleted, the method for storing a key as shown in FIG. 3 may be applied to the transaction process of Ethereum.

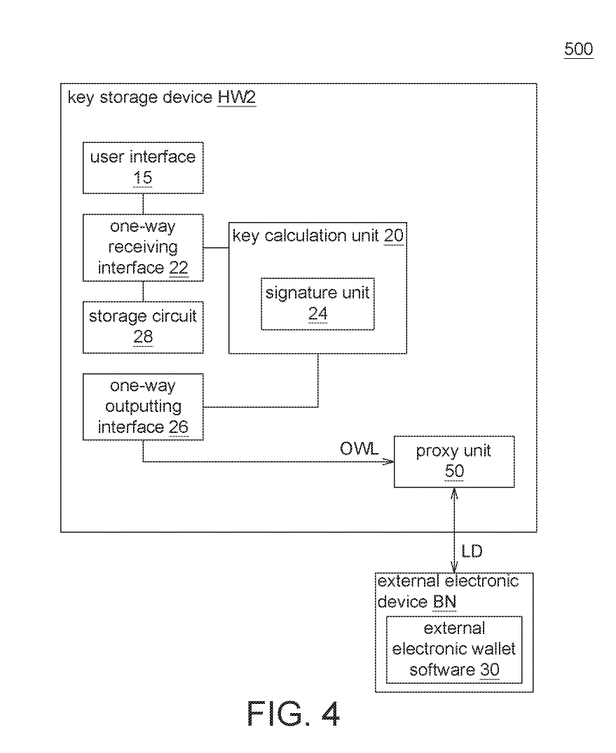

Referring to FIG. 4, FIG. 4 is a block diagram of a transaction system 500 according to one embodiment of the present disclosure. The difference between FIG. 4 and FIG. 1 is that the key storage device HW2 in FIG. 4 further comprises the proxy unit 50. The key calculation unit 20 in FIG. 4 comprises a one-way receiving interface 22, a signature unit 24, a one-way outputting interface 26 and a storage circuit 28. The one-way outputting interface 26 transmits the signature message to the proxy unit 50 via the one-way link OWL in a single direction. The proxy unit 50 performs a bidirectional transmission connection with the external electronic device BN via the bidirectional transmission interface. And, the proxy unit 50 transmits the signature message to the external electronic device BN via the bidirectional transmission connection. The one-way receiving interface 22, the key calculation unit 20, the signature unit 24, the one-way outputting interface 26 and the storage circuit 28 in FIG. 4 has the same functions as the corresponding component in FIG. 1. Thus, it is no more further description herein. In another embodiment, the key storage device HW2 in FIG. 4 can be combined or embedded in the desktop, server, smart phone, panel or other electronic device with calculating function.

In one embodiment, the one-way receiving interface 22 can be a QR code scanner, a bar code scanner or a unidirectional receiver, such as light, sound waves, infrared receiver. The one-way outputting interface 26 can be a QR code encoder, a bar code encoder or a unidirectional emitter, such as light, sound waves, infrared emitter. In another embodiment, the one-way outputting interface 26 can be further modified by a hardware optical transceiver channel, a serial port interface (such as an interface standard RS-232, RS-422, RS-485), an inter-integrated circuit (I2C), serial peripheral interface (SPI) or parallel I/O protocol interface, etc., as to be a one-way transmission or reception interface. For example, the one-way outputting interface 26 can be RS-232 interface with further disable the circuit of the receiver port RX of RS-232. In another embodiment, the one-way outputting interface 26 can be implemented by software. The one-way outputting interface 26 can be implemented by logical isolation interface of software (such as firewall). By logical isolation interface of the software, the one-way outputting interface 26 can isolate the request signal or data from the external electronic device BN.

In one embodiment, the proxy unit 50 can be implemented by a microcontroller, a microprocessor, a digital signal processor, an application specific integrated circuit (ASIC), or a logic circuit.

In one embodiment, the proxy unit 50 performs a bidirectional transmission link LD to the external electronic device BN via a bidirectional transmission interface. The one-way outputting interface 26 transmits the signature message to the proxy unit 50 by the one-way link OWL, and the proxy unit 50 transmits the signature message to the external electronic device BN by the bidirectional transmission link LD. Therefore, the signature message transmitted by the communication between the one-way outputting interface 26 and the proxy unit 50 is unidirectional. As such, even the communication between the proxy unit 50 and the external electronic device BN is the bidirectional transmission link LD, the external electronic device BN still cannot transmit request or data back to the one-way outputting interface 26.

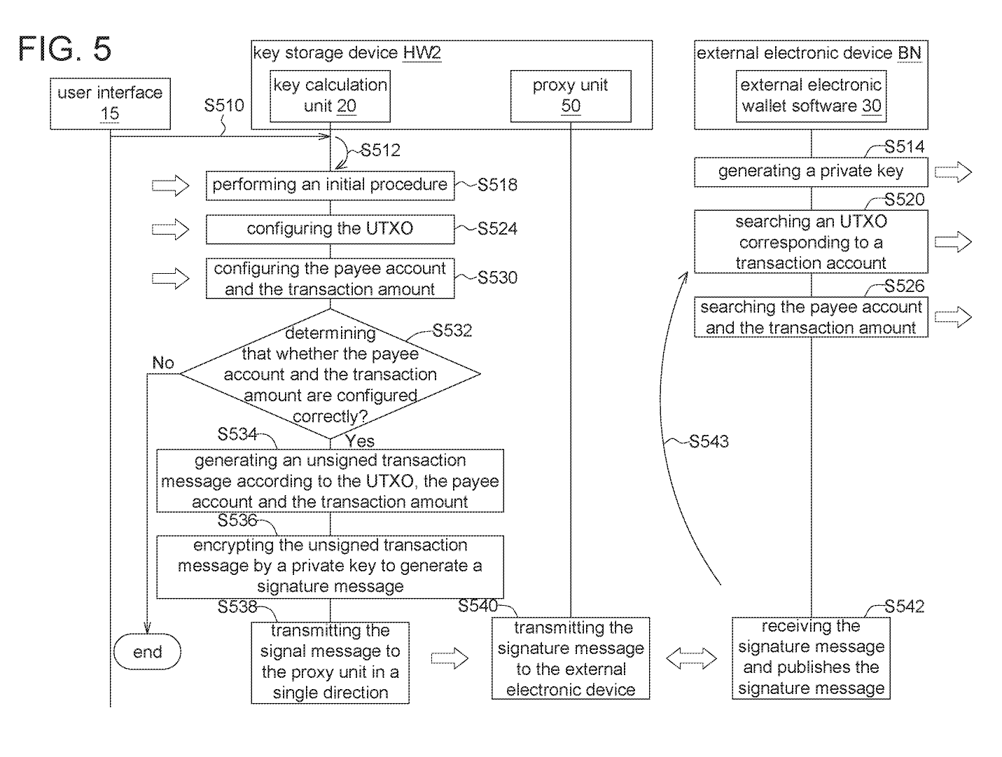

Referring to FIGS. 2, 4-5, FIG. 5 is a schematic diagram of the transaction method of key storage device according to one embodiment of the present disclosure. FIG. 5 can be implemented according to the components of the key storage device mentioned in FIG. 4. In one embodiment, in step S514, the external electronic wallet software 30 generates a private key. In step S518, the key calculation unit 20 of the key storage device HW2 receives the private key transmitted from the external electronic device BN in a single direction, configures and stores the private key to finish the initial procedure of key storage device HW2. In one embodiment, in step S520, after the external electronic device BN searching the UTXO corresponding to the transaction account, the external electronic device BN generates and displays the QR code according to the UTXO. In step S524, the key calculation unit 20 of the key storage device HW2 scans the QR code displayed by the external electronic device BN, and the key calculation unit 20 configures the UTXO.

In step S526, the external electronic device BN searches the payee account and the transaction amount.

In one embodiment, in step S526, after the external electronic wallet software 30 of the external electronic device BN searches the payee account and the transaction amount, the external electronic device BN generates and displays the QR code according to the payee account and the transaction amount by the external electronic wallet software 30. After the key calculation unit 20 of the key storage device HW2 scans the QR code displayed by the external electronic device BN to obtain the payee account and the transaction amount, the key calculation unit 20 configures the payee account and the transaction amount and stores the payee account and the transaction amount in the storage circuit 28. In another embodiment, the external electronic wallet software 30 of the external electronic device BN searches the payee account corresponding to the transaction account and encodes the payee account to the QR code. The key storage device HW2 receives the payee account, and the user uses the user interface 15 to input a transaction amount, and stores the transaction amount to the storage circuit 28. In this manner, the key storage device HW2 finishes configuring and storing the payee account and the transaction amount.

In step S530, the key calculation unit 20 configures the payee account and the transaction amount.

Besides, the steps S510, S512, S514, S518, S520, S524, S526, S530, S532, S534, S536, S542, and S543 in FIG. 5 separately are as same as the steps S210, S212, S214, S218, S220, S224, S226, S232, S234, S236, S242, and S243 in FIG. 2. Thus, it is no more further description herein. The difference between FIG. 5 and FIG. 2 is that FIG. 5 applies the proxy unit 50 shown in FIG. 4, and the step S540 is further included between steps S538 and S542 in FIG. 5. In step S532, the key calculation unit 20 determines that whether the payee account and the transaction amount are configured correctly. If the payee account and the transaction amount are configured correctly, the step S534 is performed. If the payee account and the transaction amount are not configured correctly, the process is ended. Besides, the steps S536, S538, S540 and S542 are described in detail below.

In step S536, the signature unit 24 reads the unsigned transaction message from the storage circuit, encrypts the unsigned transaction message by the private key to generate the signature message, and transmits the signature message to the one-way outputting interface 26.

In step S538, the one-way outputting interface 26 transmits the signal message to the proxy unit 50 in a single direction.

In step S540, the proxy unit 50 transmits the signature message to the external electronic device BN.

In step S542, the external electronic device BN receives the signature message and publishes the signature message.

Based on above, the one-way outputting interface 26 can unidirectionally transmit the signature message to the proxy unit 50. The proxy unit 50 transmits the signature message to the external electronic device BN. The communication between the one-way outputting interface 26 and the proxy unit 50 is unidirectional. The communication between the proxy unit 50 and the external electronic device BN can be bidirectional. As such, it can make sure that the external electronic device BN cannot obtain the other information (e.g., private key) stored in the key storage device HW2 via the proxy unit 50.

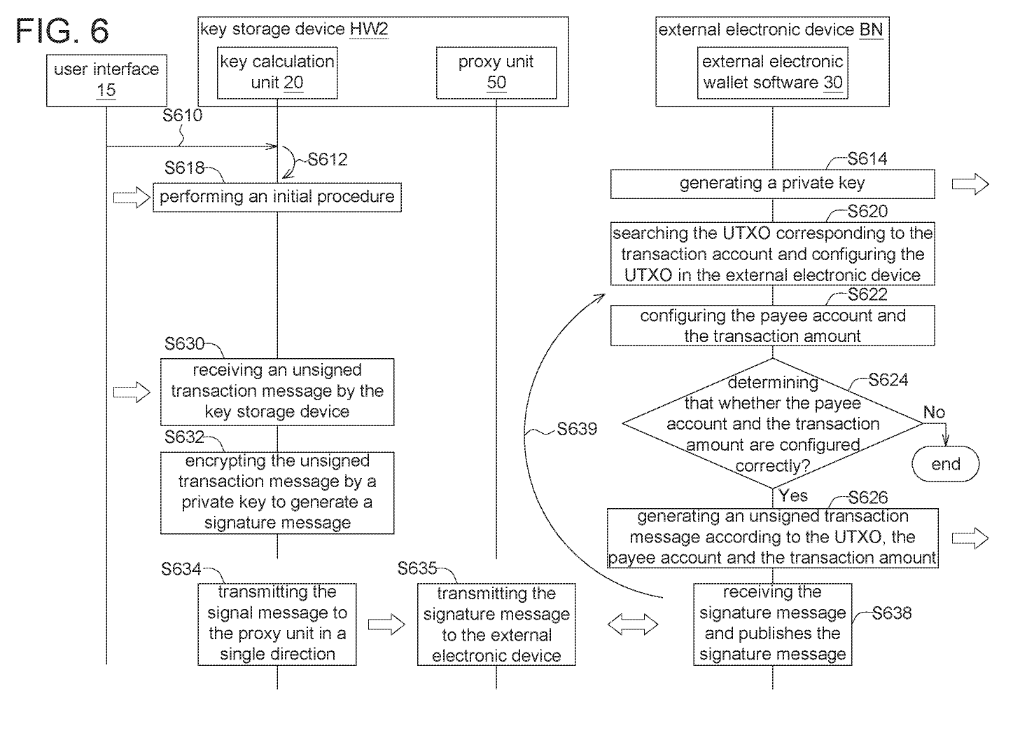

Referring to FIG. 6, FIG. 6 is a schematic diagram of the transaction method of key storage device according to one embodiment of the present disclosure. The steps S610, S612, S618, S614, S620, S622, S624, S626, S630, S632, and S639 in FIG. 6 separately are as same as the steps S310, S312, S314, S318, S320, S322, S324, S326, S330, S332, and S339 in FIG. 3. Thus, it is no more further description herein. The difference between FIG. 6 and FIG. 3 is that FIG. 6 applies the proxy unit 50 shown in FIG. 4, and the step S635 is further included between steps S634 and S638 in FIG. 6. In step S624, the external electronic wallet software 30 determines that whether the payee account and the transaction amount are configured correctly. If the payee account and the transaction amount are configured correctly, the step S626 is performed. If the payee account and the transaction amount are not configured correctly, the process is ended. The steps S634, S635 and S638 are described in detail below.

In step S634, the one-way outputting interface 26 transmits the signature message to the proxy unit 50 in a single direction.

In step S635, the proxy unit 50 transmits the signature message to the external electronic device BN.

In step S638, the external electronic device BN receives the signature message and publishes the signature message.

Based on above, in the embodiment of FIG. 6, the UTXO is searched and configured by the external electronic device BN (step S620), and the payee account and the transaction amount is configured by the external electronic device BN (step S622). The key storage device HW2 cannot obtain these messages. Therefore, the transaction related to the configurations can be more efficiently finished by directly processing on the external electronic device BN. And then, the key storage device HW2 can sign the messages related to the transaction. It can reduce the calculation loading of the key storage device HW2. Besides, the one-way outputting interface 26 can transmits the signature message to the proxy unit 50 in a single direction. The proxy unit 50 transmits the signature message to the external electronic device BN. The communication between the one-way outputting interface 26 and the proxy unit 50 is unidirectional. The communication between the proxy unit 50 and the external electronic device BN can be bi-directional. As such, it can make sure that the external electronic device BN cannot obtain the other information (e.g., private key) stored in the key storage device HW2 via the proxy unit 50.

Based on above, the present disclosure provides a key storage device, a transaction method of key storage device, a transaction system and a transaction method can establish the one-way link to the external electronic device by the one-way receiving/outputting interface, so as to use the one-way outputting interface transmits the signature message to the external electronic device via the output port. Based on using the one-way transmission method to transmit the signature message transmission, the one-way outputting interface cannot receive the access information from the external electronic device. Therefore, the one-way link can avoid the external electronic device invading the one-way outputting interface to obtain other information. Thus, the transaction method of key storage device, the transaction system and the transaction method can achieve the effect of increasing the safety of transaction.

Although the present disclosure has been described in considerable detail with reference to certain embodiments thereof, other embodiments are possible. Therefore, the scope of the appended claims should not be limited to the description of the embodiments contained herein.

What is claimed is:

1. A key storage device, comprising:
a one-way receiving interface, configured to receive a transaction message of an external electronic device in a single direction;
a key calculation unit, comprising:
a signature unit, configured to encrypt the transaction message by a private key to generate a signature message; and
a one-way outputting interface, configured to transmit the signature message to the external electronic device in a single direction.

2. The key storage device of claim 1, wherein the key calculation unit generates an unsigned transaction message according to the transaction message received from the one-way receiving interface, and the key calculation unit stores the unsigned transaction message in a storage circuit; the signature unit reads the unsigned transaction message from the storage circuit, encrypts the unsigned transaction message by the private key to generate the signature message, and transmits the signature message to the one-way outputting interface;
wherein a communication between the one-way outputting interface and the external electronic device is a one-way link, and the one-way outputting interface transmits the signature message to the external electronic device by an outputting port.

3. The key storage device of claim 1, wherein the transaction message comprises a payee account, an unspent transaction output (UTXO) or a transaction amount.

4. The key storage device of claim 1, further comprising:
a user interface, configured to receive a transaction amount and transmit the transaction amount to the one-way receiving interface.

5. The key storage device of claim 1, wherein the one-way receiving interface receives the private key and configures the private key before the one-way receiving interface receives a first transaction message.

6. The key storage device of claim 5, wherein the one-way receiving interface receives a personal identification number code and the key calculation unit performs a user identity verification according to the personal identification number code before the one-way receiving interface receives the first transaction message or before the one-way receiving interface receives and configures the private key.

7. The key storage device of claim 1, wherein the one-way receiving interface receives the transaction message and the private key by scanning a quick response code (QR code) or a bar code.

8. The key storage device of claim 1, further comprising:
a proxy unit, configured to perform a bidirectional transmission link to the external electronic device via a bidirectional transmission interface;
wherein the one-way outputting interface transmits the signature message to the proxy unit by single direction, and the proxy unit transmits the signature message to the external electronic device by the bidirectional transmission link.

9. A transaction method of key storage device, comprising:
receiving a transaction message of an external electronic device in a single direction by a one-way receiving interface;
encrypting the transaction message by a private key to generate a signature message by a signature unit; and
transmitting the signature message to the external electronic device in a single direction by a one-way outputting interface.

10. The transaction method of key storage device of claim 9, wherein a key calculation unit generates an unsigned transaction message according to the transaction message received from the one-way receiving interface, and the key calculation unit stores the unsigned transaction message in a storage circuit; the signature unit reads the unsigned transaction message from the storage circuit, encrypts the unsigned transaction message by the private key to generate the signature message, and transmits the signature message to the one-way outputting interface;
wherein a communication between the one-way outputting interface and the external electronic device is a one-way link, and the one-way outputting interface transmits the signature message to the external electronic device by an outputting port; the one-way outputting interface is unable to receive an accessing information from the external electronic device.

11. The transaction method of key storage device of claim 9, wherein the transaction message comprises a payee account, an unspent transaction output (UTXO) or a transaction amount.

12. The transaction method of key storage device of claim 9, further comprising:
receiving a transaction amount and transmit the transaction amount to the one-way receiving interface by a user interface.

13. The transaction method of key storage device of claim 9, further comprising:
receiving and configuring the private key from the external electronic device before receiving a first transaction message.

14. The transaction method of key storage device of claim 13, further comprising:
receiving a personal identification number code and performing a user identity verification according to the personal identification number code before receiving the first transaction message or before receiving and configuring the private key.

15. The transaction method of key storage device of claim 9, further comprising:
receiving the transaction message and the private key by scanning a quick response code (QR code) or a bar code.

16. The transaction method of key storage device of claim 9, further comprising:
performing a bidirectional transmission link to the external electronic device via a bidirectional transmission interface by a proxy unit;
wherein the one-way outputting interface transmits the signature message to the proxy unit by single direction, and the proxy unit transmits the signature message to the external electronic device by the bidirectional transmission link.

17. The transaction method of key storage device of claim 9, further comprising:
generating the private key by the external electronic device;
performing an initial procedure by a key calculation unit;
searching an unspent transaction output corresponding to a transaction account; wherein the key calculation unit configures the unspent transaction output;
searching a payee account and a transaction amount by the external electronic device; wherein the key calculation unit configures the payee account and the transaction amount;
determining that whether the payee account and the transaction amount are correct by the key calculation unit;
if the payee account and the transaction amount are correct, the key calculation unit generates an unsigned transaction message according to the unspent transaction output, the payee account and the transaction amount;
encrypting the unsigned transaction message by the private key to generate the signature message; and
transmitting the signature message to the external electronic device in a single direction by the one-way outputting interface.

18. The transaction method of key storage device of claim 9, further comprising:
generating the private key by the external electronic device;
performing an initial procedure by a key calculation unit;
configuring an unspent transaction output corresponding to a transaction account by the external electronic device;
configuring a payee account and a transaction amount by the external electronic device;
determining that whether the payee account and the transaction amount are correct by the key calculation unit;
if the payee account and the transaction amount are correct, the external electronic device generates an unsigned transaction message according to the unspent transaction output, the payee account and the transaction amount, and the key calculation unit receives the unsigned transaction message;
encrypting the unsigned transaction message by the private key to generate the signature message; and
transmitting the signature message to the external electronic device in a single direction by the one-way outputting interface.

19. A key storage device, comprising:
a proxy unit, configured to perform a bidirectional transmission link to an external electronic device via a bidirectional transmission interface;
a one-way receiving interface, configured to receive a transaction message of the external electronic device in a single direction;
a key calculation unit, comprising:
a signature unit, configured to encrypt the transaction message by a private key to generate a signature message; and
a one-way outputting interface, configured to transmit the signature message to the proxy unit, and the proxy unit transmits the signature message to the external electronic device in a single direction.

20. The key storage device of claim 19, wherein the key calculation unit generates an unsigned transaction message according to the transaction message received from the one-way receiving interface, and the key calculation unit stores the unsigned transaction message in a storage circuit; the signature unit reads the unsigned transaction message from the storage circuit, encrypts the unsigned transaction message by the private key to generate the signature message, and transmits the signature message to the one-way outputting interface.

21. The key storage device of claim 19, wherein the transaction message comprises a payee account, an unspent transaction output (UTXO) or a transaction amount.

22. The key storage device of claim 19, further comprising:
a user interface, configured to receive a transaction amount and transmit the transaction amount to the one-way receiving interface.

23. The key storage device of claim 19, wherein the one-way receiving interface receives the private key and configures the private key before the one-way receiving interface receives a first transaction message.

24. The key storage device of claim 23, wherein the one-way receiving interface receives a personal identification number code and the key calculation unit performs a user identity verification according to the personal identification number code before the one-way receiving interface receives the first transaction message or before the one-way receiving interface receives and configures the private key.

25. The key storage device of claim 19, wherein the one-way receiving interface receives the transaction message and the private key by scanning a quick response code (QR code) or a bar code.

26. A transaction system, comprising:
an external electronic device, configured to transmit or display a transaction message;
a key storage device, comprising:
a proxy unit, configured to perform a bidirectional transmission link to the external electronic device via a bidirectional transmission interface;
a one-way receiving interface, configured to receive the transaction message of the external electronic device in a single direction;
a key calculation unit, comprising:
a signature unit, configured to encrypt the transaction message by a private key to generate a signature message; and
a one-way outputting interface, configured to transmit the signature message to the proxy unit, and the proxy unit transmits the signature message to the external electronic device in a single direction.

27. A transaction method, comprising:
transmitting or display a transaction message by an external electronic device;
performing a bidirectional transmission link to the external electronic device via a bidirectional transmission interface by a proxy unit;
receiving the transaction message of the external electronic device in a single direction by a one-way receiving interface;
encrypting the transaction message by a private key to generate a signature message by a signature unit; and
transmitting the signature message to the proxy unit, and the proxy unit transmits the signature message to the external electronic device in a single direction by a one-way outputting interface.

28. The transaction method of claim 27, further comprising:
generating the private key by the external electronic device;
performing an initial procedure by a key calculation unit;
searching an unspent transaction output corresponding to a transaction account by the external electronic device; wherein the key calculation unit configures the unspent transaction output;
searching a payee account and a transaction amount by the external electronic device; wherein the key calculation unit configures the payee account and the transaction amount;
determining that whether the payee account and the transaction amount are correct by the key calculation unit;
if the payee account and the transaction amount are correct, the key calculation unit generates an unsigned transaction message according to the unspent transaction output, the payee account and the transaction amount;
encrypting the unsigned transaction message by the private key to generate the signature message; and
transmitting the signature message to the proxy unit in a single direction by the one-way outputting interface; wherein the proxy unit transmits the signature message to the external electronic device.

29. The transaction method of key storage device of claim 27, further comprising:
generating the private key by the external electronic device;
performing an initial procedure by a key calculation unit;
configuring an unspent transaction output corresponding to a transaction account by the external electronic device;
configuring a payee account and a transaction amount by the external electronic device, and determining that whether the payee account and the transaction amount are correct by the external electronic device;
if the payee account and the transaction amount are correct, the external electronic device generates an unsigned transaction message according to the unspent transaction output, the payee account and the transaction amount, and the key calculation unit receives the unsigned transaction message;
encrypting the unsigned transaction message by the private key to generate the signature message; and
transmitting the signature message to the proxy unit in a single direction by the one-way outputting interface; wherein the proxy unit transmits the signature message to the external electronic device.
